(19) United States
(12) Patent Application Publication
(10) Pub. No.: US 2025/0014373 A1
(43) Pub. Date: Jan. 9, 2025

(54) DIFFERENTIATE POSITIVE AND NEGATIVE WEAK LABELS WITH ROBUST TRAINING IN BOOTSTRAPPING FRAMEWORK

(71) Applicant: Robert Bosch GmbH, Stuttgart (DE)

(72) Inventors: Rakesh Radhakrishnan MENON, Chapel Hill, NC (US); Bingqing WANG, San Jose, CA (US); Jun ARAKI, San Jose, CA (US); Zhengyu ZHOU, Fremont, CA (US); Zhe FENG, Mountain View, CA (US)

(21) Appl. No.: 18/345,162

(22) Filed: Jun. 30, 2023

(51) Int. Cl. G06V 30/19; G06F 40/295

(52) U.S. Cl. CPC G06V 30/19147; G06F 40/295; G06V 30/19173

(57) ABSTRACT

A plurality of weak label augmenters of different paradigms are integrated into a framework using robust training and negative instance filtering. A first of the augmenters extracts first weak labels from unlabeled data, a second of the augmenters extracts second weak labels from the unlabeled data. The robust training is used with an objective to downweight the probability of entities belonging to the wrong category. The first and second weak labels are filtered using an instance filter to update a high-precision training set shared by the plurality of augmenters. The plurality of augmenters are iteratively retrained using the updated high-precision training set to improve recognition performance over iterations.

### TECHNICAL FIELD

Aspects of the disclosure relate to differentiate positive and negative weak labels with robust training in a bootstrapping framework.

### BACKGROUND

Within the domain of information extraction (IE), named entity recognition (NER) is defined as the task of identifying entities of specific types in a given document. To solve this task with deep learning, large labeled datasets may be accumulated corresponding to the required entity types. These datasets are used to train models that can label new documents effectively. However, accumulating the large labeled datasets can be an expensive process. Moreover, it is impractical to assume the availability of labeled datasets for all types of documents.

### SUMMARY

In one or more illustrative examples, systems and methods are provided for iteratively training a machine-learning model to perform named-entity recognition of unlabeled text data utilizing a co-augmentation framework includes integrating a plurality of weak label augmenters of different paradigms. A first of the augmenters extracts first weak labels from unlabeled data. A second of the augmenters extracts second weak labels from the unlabeled data. The first and second weak labels are filtered using a negative instance filter to update a high-precision training set shared by the plurality of augmenters. The plurality of augmenters are iteratively retrained using the updated high-precision training set, thereby improving recognition performance over iterations.

In one or more illustrative examples, the plurality of weak label augmenters includes a rule augmenter, and the method further includes extracting, by a rule applier of the rule augmenter, the first weak labels based on the unlabeled data using given seed rules; using the high-precision training set, as updated based on the first weak labels filtered by the instance filter, to train a neural named entity recognition (NER) model to identify predicted labels in the unlabeled data; extracting rules from the predicted labels; and adding selected rules from the extracted rules to enlarge the seed rules.

In one or more illustrative examples, the method includes utilizing the neural NER model, once trained, to perform named-entity recognition on an unlabeled input text.

In one or more illustrative examples, the plurality of weak label augmenters includes a label augmenter, and the method includes training the label augmenter with a robust model labeler, given input seed labels; extracting the second weak labels from the unlabeled data using the robust model labeler, as trained; and using the high-precision training set, as updated based on the second weak labels filtered by the instance filter, to retrain the robust model labeler of the label augmenter.

In one or more illustrative examples, the label augmenter adopts a loss function that includes a weighting of components, the components including one or more of: an unlikelihood objective for class contradiction, for maximizing a probability difference between entities belonging to a correct class in the high-precision training set as compared to entities belonging to another class in the high-precision training set; a minmax entropy optimization approach for prototype re-estimation to minimize entropy given to training data and to maximize entropy on entities that cannot be labeled, to avoid bias against unlabeled entities; and/or an anchor regularizer to limit prototype drift at a current iteration to a maximum distance from prototype embedding at one or more initial iterations.

In one or more illustrative examples, each class is considered as a centroid of all instances in that class and wherein distance measurements utilized by the loss function are computed as Euclidean distance from the centroid.

In one or more illustrative examples, the minmax entropy optimization approach utilizes a gradient reversal layer such that data with a label contributes a positive entropy in the loss function, and data without a label contributes a negative entropy in the loss function.

In one or more illustrative examples, the label augmenter implements the model labeler as a bidirectional encoder representations from transformer (BERT) masked-language model.

In one or more illustrative examples, the instance filter utilizes a rule-based constraint functions to remove the weak labels that match to one or more predefined constraint rules to prevent their incorporation into the high-precision training set.

In one or more illustrative examples, the instance filter utilizes a neural constraint module to jointly learn and filter negative instances, where the neural constraint module only filters instances that have been added by both of the first and second augmenters.

In one or more illustrative examples, the instance filter utilizes an integrated gradients-based approach to predict whether or not an entity candidate belongs to a target entity class.

### BRIEF DESCRIPTION OF THE DRAWINGS

FIG. 1 illustrates an example co-augmentation framework implementing differentiate positive and negative weak labels with robust training;

FIG. 2 illustrates a graphical example of the addition of entities to the high-precision training set;

FIG. 3 illustrates an example of use of a rule-based constraint for filtering negative instances for a disease entity recognition task;

FIG. 4 illustrates an example of use of an integrated gradients based filter for a disease entity recognition task;

FIG. 5 illustrates an example process for training a machine-learning model to perform named-entity recognition of unlabeled text data utilizing the co-augmentation framework; and

FIG. 6 illustrates an example of a computing device for performing aspects of the co-augmentation framework implementing differentiate positive and negative weak labels with robust training.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Disclosed herein is a co-augmentation framework, which utilizes an iterative bootstrapping process to learn new rules and labels simultaneously from unlabeled data given a small set of seed rules for the task of named entity recognition (NER). In some approaches erroneous labels are likely to be added by the empirical rule and entity selection approach in the bootstrapping process. These labels accumulate and eventually limit the performance of the system. To address this, a loss function of the neural model and a novel negative instance filtering module are introduced for better named-entity selection. For the loss function of the neural model, different techniques are considered for robustness, including unlikelihood loss for class contradiction, a minmax entropy approach to re-estimate the prototype of the entity class, and an anchor regularizer to limit the prototype drift. The modified loss function may be added on top of the ProtoBERT neural model for the NER task. For the negative instance filtering module, different strategies are possible, including the neural constraint module and Integrated Gradients (IG) to filter negative instances from the high precision instances in the bootstrapping process. With these techniques adopted, approaches to enhance the robust training and differentiate positive and negative weak labels are provided from different perspectives, which improves system performance in the bootstrapping process.

NER is a mechanism in which automated processing (e.g., computer-based processing) is applied to unstructured text in order to identify and categorize occurrences of “named entities” (e.g., people, organization, locations, etc.) in the unstructured text. For example, in some implementations, NER is a machine-learning-based natural language processing mechanism in which unstructured natural-language sentences are provided as input to a machine-learning model and the output of the machine-learning model includes an indication of an assigned category for each “entity” (or potential entity) in the sentence (e.g., words or phrases that appear in the sentence that the machine-learning model determines may correspond to proper names, objects, etc.). For example, if the input sentence provided to as input recites: “John is travelling to London,” the output of a trained NER machine-learning model may indicate the “John” is categorized as a “person” and “London” is categorized as a “location.”

In some implementations, NER is an essential task for many downstream information extraction tasks (e.g., relation extraction) and knowledge base construction. Supervised training of named-entity recognition has achieved reliable performance due, for example, to advances in deep neural models. However, supervised training of an NER model requires a large amount of manual annotation of data for training. This can require significant amounts of time in all cases but is particularly challenging in some specific domains and/or when training an NER model for low resource languages, where domain-expert annotation is difficult to obtain.

In some implementations, distantly supervised training is used to automatically extract labeled data from open knowledge bases or dictionaries. Distant supervision makes it possible to generate training data for NER models at a large scale without expensive human efforts. However, all distantly supervised methods rely on an existing knowledge base or dictionary and, in some cases, an open knowledge base is not available (e.g., in the biomedical field, technical documents, etc.).

Accordingly, in some implementations, the systems and methods described herein provide a weakly supervised mechanism for training a machine-learning NER model. A rule augmenter uses a small set of logical rules, referred to herein as seeding rules, to label data in unstructured text. In some implementations, the seeding rules and their associated labels may be provided or defined manually for a specific task (i.e., the task for which the NER model is to be trained). After applying the seeding rules to the unstructured text, the weakly-labeled data is used to train an initial iteration of an artificial neural network-based NER model. The NER model may then be used to predict more weak labels, and new rules may be generated from the weak labels. The unstructured text is also processed to identify a plurality of potential rules for labelling named entities. These new rules may be used to augment the seed rules. The NER model is then retrained based on the data as labeled by the new set of selected rules. This training process is iteratively repeated to continue to refine and improve the NER model.

In some implementations, the weakly supervised mechanism for training the NER model uses bootstrapping framework to extract weakly labeled data with logical rules and also automatically trains the NER model to recognize entities with neural representations. For example, in some implementations, the initial seeding rules may include a rule such as “located in ______” to explicitly identify at least some locations in the unstructured text.

Thus, a rule-augmentation process may be used to iteratively identify new rules and new entities as weak labels. Some approaches may also combine rule-augmentation and label-augmentation in an iterative bootstrapping procedure to improve performance given a few seed examples and a large pool of unlabeled examples. Relevant to the success of the iterative procedure is the bootstrapping process whereby new entities are extracted from massive unlabeled data in each iteration using either the rule-based module or the label-based module to train the other module.

However, such an iterative bootstrapping procedure can lead to sub-optimal models due to semantic drift. Also, some approaches may be prone to semantic drift by the presence of erroneously labeled instances during the bootstrapping process. In this disclosure, techniques are provided to mitigate this issue with robust training procedures and negative instance filtering, which as described below in detail.

A framework may be provided that is capable of learning robust named-entity taggers using a small set of seed rules and a large amount of unlabeled data. This framework may be built onto an iterative process through which rule-augmentation and label augmentation can be combined to label unlabeled examples. The most confident labels among these are further added to the new training set for the individual components. However, applying a confidence threshold-based constraint is not restrictive enough to prevent the addition of wrong labels into the training set for the next iteration. In turn, the models trained in the next iteration have lower precision, and labeling worsens as iterations proceed. In this disclosure two key contributions include (i) techniques to improve the performance of the label augmenters in the framework, and (ii) a set of techniques that can be used to constrain the instances, beyond confidence thresholding, to prevent bootstrapping errors.

The main components of the framework may include a robust training and a negative instance filtering. The robust training may train the model with an objective to downweight the probability of entities belonging to the wrong category. The negative instance filtering may, at each iteration, once the rule augmenter and the label augmenter propose instances, apply two main techniques to prevent noisy instances from being added to the training set. These may include learning constraint models, which refer to models that do not partake in the training of the framework but can perform constraining on weak labels proposed by the framework to filter noisy instances. These may also include an integrated gradients-based constraint, which is an explainability technique that is re-purposed to compute attributions of instances towards certain categories before adding the instances to the training set. Further aspects of the disclosure are discussed in detail herein.

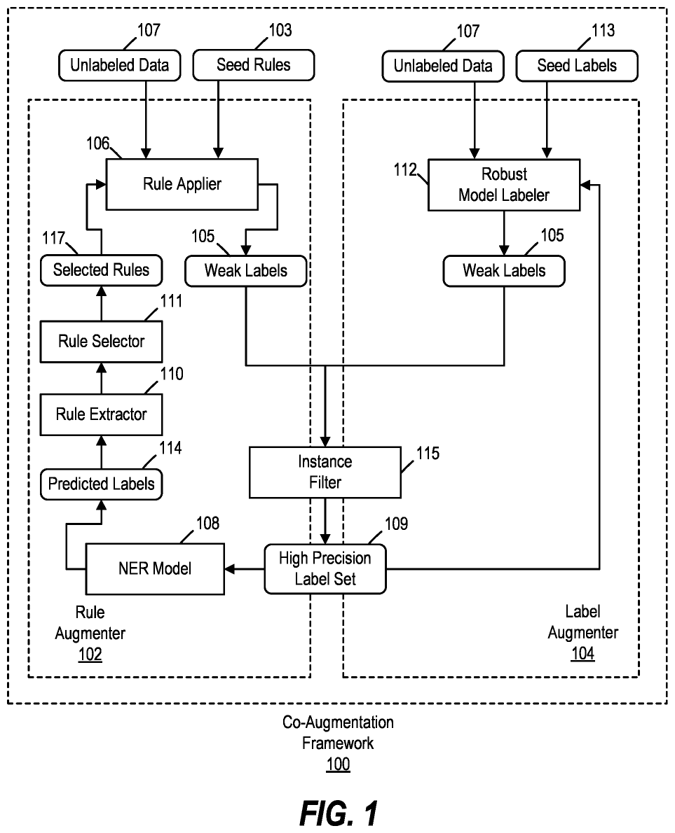

FIG. 1 illustrates an example co-augmentation framework 100 implementing differentiate positive and negative weak labels 105 with robust training. The framework 100 iteratively improves the performance of two augmenters by leveraging the bootstrapped predictions on unlabeled data by each model. This aspect is referred to herein as co-augmentation. At each learning iteration, both the rule augmenter 102 and the label augmenter 104 may acquire labeling knowledge to augment the training set based on existing seed rules 103 and manual seed labels 113. Unlike co-training, instead of improving two models that use different feature sets individually by bootstrapping labels from each other, the co-augmentation framework 100 uses two models that use different forms of supervision to expand the same label set. Additionally, in each iteration of the co-augmentation framework 100, both classifiers are trained with the predictions made by both models, rather than just one. This choice allows the framework 100 to function from small initial training sets for the individual models. The framework 100 comprises two major components: a rule augmenter 102 and a label augmenter 104. Both augmenters generate weak labels 105, which are filtered using an instance filter 115 and added into high-precision training set 109 shared by both augmenters 102, 104.

The rule augmenter 102 may include a rule applier 106, a neural NER model 108, a rule extractor 110, and a rule selector 111. The rule augmenter 102 is configured to learn new labeling rules from a small set of seed rules 103, which is further used to extract new entities from unlabeled data 107 and assign weak labels 105.

The rule applier 106 of the rule augmenter 102 may apply rules to unlabeled data 107 to obtain weak labels 105. These labels are weak labels 105 because the labels identify likely semantic entities instead of being manually assigned by a user. These weak labels 105 may be lower quality (e.g., less likely to be accurate) than manual labels, but are more efficient because a larger number of possible semantic entities can be identified in a much shorter amount of time.

The neural NER model 108 of the rule augmenter 102 may be trained on the high-precision training sets 109 and make predictions on the unlabeled data 107 to extract more candidate named entities. These predictions may result in predicted labels 114.

The rule extractor 110 of the rule augmenter 102 may receive the predicted labels 114 and use the predicted labels 114 to generate rules. The predicted labels 114 may be named entities, and new rules may be generated based on those named entities. For example, if a predicted label 114 for identification of diseases in a text is “cancer”, and the context of the word “caused by cancer,” then a generated candidate rule may include “caused by DISEASE”, where whatever word is after “caused by” is predicted to be a possible named entity of a disease. Or, if the context is “DISEASE spread heavily,” then a candidate rule is generated such that whatever word is followed by “spread heavily” is predicted to be a possible named entity of a disease.

The rule selector 111 of the rule augmenter 102 may receive the predicted labels 114 from the neural NER model 108. The rule selector 111 may score and select accurate labeling rules from candidate rules using neural NER model 108's prediction. For instance, the rule selector 111 may determine which of the generated rules are the most common and may select those common rules from the candidate rules. The rule selector 111 may therefore output selected rules 117 which may be provided to the rule applier 106 in the next iteration.

A summary of the algorithm for the rule augmenter 102 is shown below:

```
Require: [symbol]   = {x_{1:N}} unlabeled examples
Require: [symbol]   = { [symbol]   } rules initialized with seed rules
Require: [symbol]   = {c_{1:M}} candidate rules
Initialize: [symbol]     = { }
for t in (1,..., [symbol]   ) do
  // Apply rules to get weak-label set [symbol]
  = RULEAPPLIER( [symbol]   , [symbol]   )
  // Filter accurate examples [symbol]
  = LABELSELECTOR( [symbol]   ) [symbol]
  = [symbol]   ∪ [symbol] [symbol]
  = [symbol]   \ [symbol]
  // Train NEURAL NER MODEL
  M ← TRAIN(M, [symbol]   )
  // Label using NEURAL NER MODEL [symbol]
  _{M} ← PREDICT (M, [symbol]   )
  // Select High-precision Rules [symbol]
  _{S} ← RULESELECTOR( [symbol]   _{M}, [symbol]   ) [symbol]
  = [symbol]   \ [symbol]   _{S} [symbol]
  ← [symbol]   ∪ [symbol]   _{S}
end for
```

The label augmenter 104 includes a neural model that learns to perform entity recognition with minimal supervision and a label selector that selectively adds the weak labels 105 proposed by the neural model into the training set for the next iteration. To do so, the label augmenter 104 includes a robust model labeler 112 configured to augment labels from another angle, where, in an example, ProtoBERT is adopted to learn the prototype of the entity class and used to identify new entities. ProtoBERT is a bidirectional encoder representations from transformer (BERT) masked-language model composed of transformer encoder layers. ProtoBERT combines BERT's pre-trained knowledge with few-shot capabilities of prototypical networks for sequence labelling problems. A summary of the algorithm for the label augmenter 104 is shown below:

```
Require: [symbol]   = {x_{1:N}} unlabeled examples
Require: [symbol]   = { [symbol]   } rules initialized with seed rules
Require: β₀ , β₁ [symbol]    initial threshold and increment
Initialize: [symbol]   = R( [symbol]   )
for t in (1,..., [symbol]   ) do
  // Train NEURAL MODEL
  M ← TRAIN(M, [symbol]   )
  // Label using NEURAL MODEL [symbol]
  _{M} ← PREDICT(M, [symbol]   )
  // Select Examples Using Adaptive Threshold [symbol]
  _{M} ← LABELSELECTOR ( [symbol]   _{M}, β₀ + t × β₁) [symbol]
  = [symbol]   ∪ [symbol]   _{M}
end for
```

An overall outline of the operation of the framework 100 may be shown as follows:

```
Require: [symbol]   = {x_{1:N}} unlabeled examples
Require: [symbol]   = { [symbol]   } rules initialized with seed rules
Require: RuleAugmenter M₁, LabelAugmenter M₂ [symbol]
  = [symbol]   (U)
  for t in (1,..., [symbol]   ) do [symbol]
    = [symbol]   \ [symbol]
    // Apply rules to get weak-label set [symbol]
    ₁ = πr² = RULEAPPLIER ( [symbol]   , [symbol]   )
    // Filter accurate examples [symbol]
    ₁ = LABELSELECTOR( [symbol]   ₁) [symbol]
    = [symbol]   ∪ [symbol]   ₁
    // Training the RULE AUGMENTER section
    M₁ ← TRAIN(M₁, [symbol]   ) [symbol]
    ← [symbol]   ∪ UPDATERULES(M₁) [symbol]   Select high-precision rules
    // Training the LABEL AUGMENTER section
    M₂ ← TRAIN(M₂, [symbol]   ) [symbol]
    ₂ ← HIGHCONFWEAKLABEL(M₂, [symbol]   ) [symbol]    Select high-confident weak-labels [symbol]
    = [symbol]   ∪ [symbol]   ₂
  end for
```

In some examples, the rule augmenter 102 and label augmenter 104 models may be alternatively trained in successive iterations. Different from co-training, in the co-augmentation framework 100, the rule augmenter 102 (label augmenter 104) utilizes the examples that have been labeled by the rule augmenter 102 (label augmenter 104) and the label augmenter 104 (rule augmenter 102) to improve its entity recognition performance over iterations.

For robust model labeling, one of the key challenges in this bootstrapping process is that noisy or wrong weak labels 105 may be added into the training, which limits the performance of the framework 100. Thus, the label augmenter 104 may be enhanced by designing loss functions to consider multiple factors in addition to the standard likelihood objective of ProtoBERT, hoping to mitigate the errors introduced by the rule augmenter 102.

Meanwhile, for the negative instance filtering, instead of merely relying on empirical approaches to select positive labels with good quality, a label selector module in the rule augmenter 102 may be enhanced with techniques that can filter more negative labels, and eventually ensure the quality of the high-precision training set 109 used for training.

The success of neural networks can be attributed partially to the way performance scales with increasing amounts of data and model size. However, most real-world problems have limited labeled data. In such situations, neural networks tend to overfit or identify spurious correlations in data, leading to imperfect generalizations at test time. This may further exacerbate the quality of the bootstrapped instances that are augmented to the high-precision training set 109 by the label augmenter 104. Hence, robust training procedures must be incorporated to limit noisy instances caused by imperfect models.

To achieve robust training, the design of the loss function needs to consider different techniques, which include contrastive learning and prototype drift controlling, as they can affect the quality of the trained model in iterative bootstrapping procedures. In general, the loss function may include one or more of the following components (in addition to the maximum likelihood objective): the unlikelihood objective (contrastive learning) as [symbol] _{unlikelihood}, the minmax entropy of the prediction model over unlabeled data 107 (prototype drift) as [symbol] ₘᵢₙₘₐₓ, and the anchor regularizer (prototype drift) as Reg_{anchor}, while λ and η are parameters to balance among these components.

$$ℒ = {ℒ}_{unlikelihood} \pm λ \cdot {ℋ}_{minmax} + η \cdot {Reg}_{anchor} \qquad ( 1 )$$

The loss function may be mainly based on the probability model, where a prediction model may be introduced based on prototype learning. Given training data {(x₁,y₁), (x₂,y₂), . . . , (xₙ,yₙ)} of n instances for a NER task with K categories. Suppose ƒ(x) is an encoder that map the input instance x into target embedding space of M dimension. Specifically, for the ProtoBERT, the BERT model is adopted as the encoder function ƒ(x). Given the k^{th} category where k∈{1, 2, . . . , K}, the prototype can be considered as the centroid of all the instances in that category. With a few-shot learning setting, given support set S. The prototype embedding cₖ for the k^{th} category can be modeled as follows:

$${c}_{k} = \frac{1}{\vert S \vert} . {\sum }_{( {x}_{i} , {y}_{i} ) ∈ S} f ( {x}_{i} ) \qquad ( 2 )$$

$$f ( x ) ∈ {R}^{M} , {c}_{k} ∈ {R}^{M} \qquad ( 3 )$$

Following this definition, the probability of input x belonging to that k^{th} category is determined by the distance between the input instance ƒ(x) and the prototype embedding cₖ. This can be interpreted as the input instance x having the highest probability for the nearest class:

$$p ( {c}_{k} \vert x ) = p ( y = k \vert x ) = \frac{exp ( - d ( f ( x ) , {c}_{k} ) )}{{\sum }_{{k}^{′}} exp ( - d ( f ( x ) , {{c}^{′}}_{k} ) )} \qquad ( 4 )$$

Where the distance function d( . . . , . . . ) can take different forms, such as dot product of vectors or Euclidean distance.

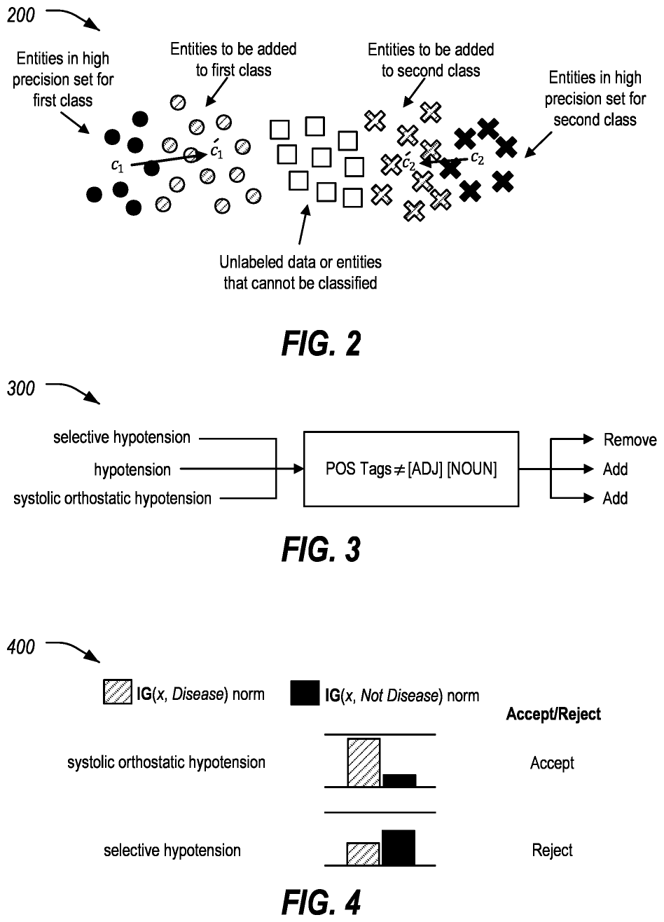

FIG. 2 illustrates a graphical example 200 of the addition of entities to the high-precision training set 109. As shown, c₁ represents entities in a first entity class in the high-precision training set 109, while ć₁ represents new entities to be added to the first entity class. Also shown, c₂ represents entities in a second, different entity class in the high-precision training set 109, while ć₂ represents new entities to be added to the second entity class. Additionally, there may exist unlabeled data 107 or entities that cannot be classified, e.g., that are not significantly closer to the centroid of one entity class than another.

Considering in the framework 100, with new entities being added into the high precision set high-precision training sets 109 each iteration, it is possible to see a drift of the prototype embedding. However, a quick shift on the prototype embedding is unexpected, which could be caused by errors in the iteration process. It may therefore be beneficial to model and find the appropriate shift amount to move embedding from cₖ to ćₖ in each iteration.

Similar to the use of few-shot methods in the area of text classification, unlikelihood loss may be used to explicitly enforce the ProtoBERT model to make representations of examples belonging to a certain class drift further away from the prototypical representations of other classes. For the ProtoBERT model, maximum likelihood loss takes the form:

$$q ( c \vert x ) = p ( {c}_{k} + {w}_{k} \vert x ) = \frac{exp ( {f ( x )}^{T} ( {c}_{k} + {w}_{k} ) )}{{\sum }_{{k}^{′} ∈ K} {f ( x )}^{T} ( {c}_{{k}^{′}} + {w}_{{k}^{′}} ) )} \qquad ( 5 )$$

$$ℒ = CE ( q ( c \vert x ) , {q}_{emp} ( c \vert x ) ) \qquad ( 6 )$$

where, at current iteration of the bootstrapping process, cₖ represents the prototype embedding estimated with newly added entities, wₖ is the shift amount of the prototype embedding, qₑₘₚ(c|x) represents the empirical distribution of x estimated from training data, p(c+w|x) or q(c|x) is the modeled distribution, and CE(.,.) represents cross-entropy between these two distributions.

With the definition of cross-entropy, the idea of unlikelihood loss is to maximize the probability difference between x belonging to the correct category, c, and the wrong categories, C\{c}. Furthermore, the unlikelihood is formed by extending from the log distribution to cross-entropy, which is given as follows:

$${ℒ}_{unlikelihood} = log q ( c \vert x ) - {\sum }_{{{c}^{′} \neq K}^{}} log q ( {c}^{′} \vert x ) \qquad ( 7 )$$

$$= CE ( q ( c \vert x ) , c ) {\sum }_{{c}^{′} \neq c} CE ( q ( {c}^{′} \vert x ) , {c}^{′} ) \qquad ( 8 )$$

So far, the loss function is already a function of parameters in ƒ(x) and parameter w the embedding shift amount.

A minmax entropy approach has been introduced to address the domain transfer problem in computer vision. The bootstrapping iteration may share some similarities with the domain transfer problem, as new entities would be added in each iteration. Thus, it may be advantageous to apply the minmax entropy approach to the loss function here.

The key approach in Minmax entropy is to model the entropy of distribution q(c|x), defined as follows:

$$H = - {\sum }_{c ∈ K} q ( c \vert x ) log ( q ( c \vert x ) ) \qquad ( 9 )$$

The entropy H can be calculated over different datasets. If calculated with existing training data, it is desired for the entropy to be lower, which means that the model is relatively more sure about the probability given input x. Instead, if calculated with unlabeled entities, the entropy should be higher, so the model does not hold any bias against unlabeled entities or entities with no labels. This can further help to control the drift of prototype embedding, stopping it from drifting towards the unlabeled entities and entities that cannot be categorized into existing classes. As the name indicated, “minmax” is to minimize entropy given training data, max entropy on entities that cannot be labeled.

In practical implementation, gradient reversal layer is adopted, which can achieve similar performance as the following Loss function shows:

$$Given data with label : ℒ = {ℒ}_{unlikelihood} + η \cdot {Reg}_{anchor} + λ \cdot {ℋ}_{minmax} \qquad ( 10 )$$

$$Given data with out label : ℒ = {ℒ}_{unlikelihood} + η \cdot {Reg}_{anchor} - λ \cdot {ℋ}_{minmax} \qquad ( 11 )$$

$$where λ is a parameter \qquad ( 12 )$$

Anchor Regularization is next discussed. Eventually, to prevent the new prototype embedding drift much away from the original prototype embedding, the distance can be calculated between the prototype embedding in the early phase and the prototype embedding at the current iteration:

$$Reg = d ( {c}^{i} , {c}^{0} ) \qquad ( 13 )$$

where cⁱ represents the embedding in i^{th} iteration, c⁰ represents the embedding in the first iteration. And of course, not just the first iteration, the embeddings in the first L iterations can all be considered:

$${Reg}_{anchor} = {\sum }_{j ∈ 1 , 2 , … , L} {a}_{j} \cdot d ( {c}^{i} , {c}^{j} ) \qquad ( 14 )$$

where αⱼ is the weight for the prototype embedding in the first j^{th} iteration. Here, Euclidean distance or vector doc product can both be considered for measuring the distance between vectors.

With respect to negative instance filtering, despite best efforts to make models robust with various loss functions, the bootstrapping process is still susceptible to generating instances with ill-conforming weak labels 105. Such issues are pervasive when labels are extracted for unlabeled instances that are outside the boundary of the training distribution. Eventually, the bootstrapped instances hurt the performance of the neural NER model 108 over iterations in the framework 100. Hence, a post-processing module is incorporated on top of the bootstrapped instances to filter out noise. This module has been indicated as the instance filter 115 in FIG. 1. Two techniques may be used by the instance filter 115 to filter out such noisy instances from the training set.

A first technique that may be used by the instance filter 115 to filter out noisy instances is the use of constraint functions. Here, an independent constraint module is considered that only partakes in the iterative bootstrapping process by filtering noisy instances. Such a constraint module can be implemented using rule-based constraints or neural networks.

FIG. 3 illustrates an example of use of a rule-based constraint for filtering negative instances for a disease entity recognition task. For example, as shown in the example 300, the constraints can be defined as using rules such as, “if an instance has the part-of-speech tags ‘[ADJ][NOUN]’, then remove such an instance from the training set” since it is likely to be a noisy instance. Here, the weak label 105 for “selective hypotension” is removed, as selective is an adjective and hypotension is a noun. However, the weak labels 105 for “hypotension” and “systolic orthostatic hypotension” are not a match to the part-of-speech tags specified by the rule. Thus, these weak labels 105 may be allowed to proceed through the instance filter 115.

However, designing constraints to filter instances can be difficult for a diverse set of tasks. Hence, building on work related to constrained semi-supervised learning, neural constraint modules may be learned jointly with the bootstrapping process of the co-augmentation framework 100. Based on the confidence of the constraint module on each instance, the framework 100 can selectively allow instances to be added to the high-precision set of the framework 100. The difference between the constraint module and the label augmenter 104 module is functional. While the label augmenter 104 proposes weak labels 105 for unlabeled data 107, the constraint module only filters instances that have been added by the rule augmenter 102 and label augmenter 104. Also, using strong pre-trained models, which has been shown to perform well on few-shot NER, for the constraint module can deliver large benefits for the framework 100.

A second technique that may be used by the instance filter 115 to filter out noisy instances is an integrated gradients-based constraint. Integrated Gradients (IG) is an explainability metric used to compute the attribution of each token in some example text towards making a particular classification decision by a model. Intuitively, the metric provides insight into the factors that lead the model under consideration towards making a particular decision. For example, assume a classification model for the task of review-sentiment classification to decipher between the positive and negative sentiments in movie reviews. Further, say there is a review text, ‘It was a bad movie.’, which the classification model determines to have a negative sentiment. IG can be used to check the contribution of each word in the review toward classifying this example as one of negative sentiment. In this particular case, it would be expected for the IG to assign a higher attribution score to the word ‘bad’ as opposed to the rest of the words in the context. However, if ‘bad’ does not obtain the highest score, then it can be concluded that the classification model uses some spurious correlation in the example to assign the negative class.

Formally, IG is computed using a gradient-based approach. Let there be an input text, x, for which a model, ƒ(.; θ), assigns the class c(∈C). IG uses an uninformative baseline b (usually an empty sequence) in combination with x to compute the contribution of each token. Here, the intuition is that if the decision between ƒ(x; θ) and ƒ(\tilde{x}; θ) (where \tilde{x} is some combination of x and b) is different, then some portions of the text have a non-zero attribution towards the classification. The equation for computing IG is given as:

$$IG ( x , c ) = ( x - b ) ⊙ \frac{1}{k} {\sum }_{i = 1}^{k} {∇}_{{\tilde{x}}_{i}} {f ( {\tilde{x}}_{i} ; θ )}_{c} \qquad ( 15 )$$

IGs may be repurposed to filter noisy instances in the high-precision training set 109. Elaborating on this approach, consider a weakly-labeled instance (x, e, c), where x is the sentence, e is the selected entity, and c is the weakly labeled category. Next, the neural NER model 108 in the rule augmenter 102 is utilized to compute the IG attribution for each word in e towards classifying the instance as belonging to each of the C categories. If the norm of the attribution score is higher for c′≠c, then the instance is discarded from the training set; if the norm is the same or lower, then the model is trained in the next iteration using the instance in consideration.

FIG. 4 illustrates an example 400 of use of an IG-based filter for a disease entity recognition task. The accept/reject nomenclature refers to whether the instance will be accepted or rejected into the high-precision training set 109. If the model is unable to assign a higher attribution score to the weak label 105, then the label is deemed to be unreliable and is not used. Training further on such instances may drive the model to a sub-optima in the following iteration. Hence, this intervention, by removing such instances from the high-precision training set 109, help the framework 100 to improve reliably over iterations.

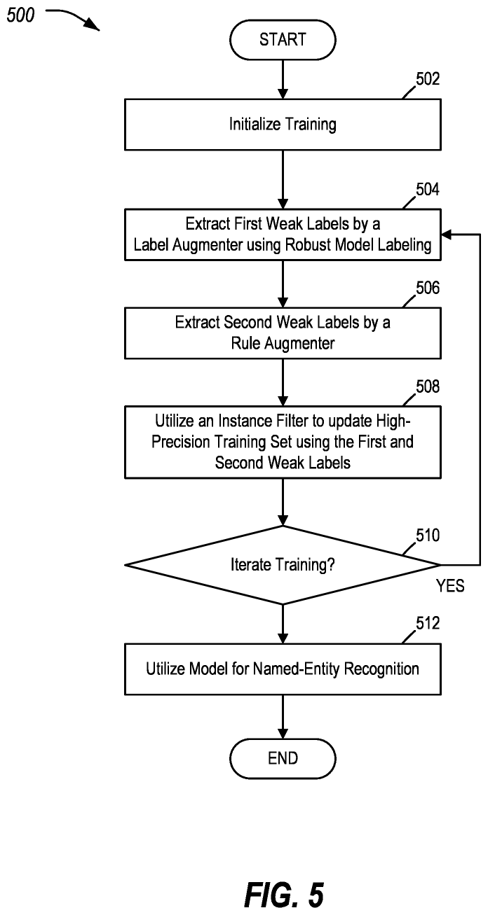

FIG. 5 illustrates an example process 500 for training a machine-learning model to perform named-entity recognition of unlabeled text data utilizing the co-augmentation framework 100. In an example, the process 500 may be performed using the framework 100 discussed in detail herein. It should be noted that while certain operations of the process 500 are shown sequentially, one or more of these operations may be performed concurrently and/or continuously.

In general, the process 500 may integrate a plurality of weak label 105 augmenters of different paradigms, a first of the augmenters generating first weak labels 105 from unlabeled data 107, a second of the augmenters generating second weak labels 105 from the unlabeled data 107. The process 500 may further involve filtering the first and second weak labels 105 using an instance filter 115 to update a high-precision training set 109 shared by the plurality of augmenters, and iteratively retraining the plurality of augmenters using the updated high-precision training set 109 to improve recognition performance over iterations.

More specifically, at operation 502, the framework 100 initializes the training. In an example, the framework 100 may access unlabeled data 107, seed rules 103, and seed labels 113 to initiate the training. This unlabeled data 107, seed rules 103, and seed labels 113 may be provided or defined manually for a specific task, e.g., the task for which the neural NER model 108 is to be trained.

At operation 504, the framework 100 extracts first weak labels 105 using the label augmenter 104. The label augmenter 104 may adopt a loss function that includes a weighting of components, the components including one or more of: an unlikelihood objective for class contradiction, by maximizing a probability difference between entities belonging to a correct class in the high-precision training set 109 as compared to belonging to another class in the high-precision training set 109; a minmax entropy optimization approach for prototype re-estimation to minimize entropy given to training data and to maximize entropy on entities that cannot be labeled to avoid bias against unlabeled entities; and/or an anchor regularizer to limit prototype drift at a current iteration to a maximum distance from prototype embedding at one or more initial iterations. Each class may be considered as a centroid of all instances in that class, and distance measurements utilized by the loss function are computed as Euclidean distance from the centroid. The label augmenter may implement the model labeler 112 as a BERT masked-language model. The minmax entropy optimization approach utilizes a gradient reversal layer such that data with a label contributes a positive entropy in the loss function, and data without a label contributes a negative entropy in the loss function.

At operation 506, the framework 100 extracts second weak labels 105 using the rule augmenter 102. The rule augmenter 102 may include a rule applier 106, a neural NER model 108, and a rule selector 111. The rule applier 106 may apply rules to unlabeled data 107 to obtain weak labels 105. The neural NER model 108 may be trained on the high precision data and make predictions on the unlabeled data 107 to extract more candidate named entities. The rule selector 111 may score and select accurate labeling rules from candidate rules using neural NER model 108's prediction. The rule augmenter 102 may accordingly learn new labeling rules from a small set of seed rules 103, which may be used to extract new entities from unlabeled data 107 and assign weak labels 105.

At operation 508, the framework 100 utilizes the instance filter 115 to update the high-precision training set 109 using the first weak labels 105 and the second weak labels 105. In an example, the instance filter 115 utilizes a rule-based constraint functions to remove the weak labels 105 that match to one or more predefined constraint rules to prevent their incorporation into the high-precision training set 109. In another example, the instance filter 115 utilizes a neural constraint module to jointly learn and filter negative instances, where the neural constraint module only filters instances that have been added by both of the rule augmenter 102 and the label augmenter 104. The instance filter 115 utilizes an integrated gradients-based approach to predict whether or not an entity candidate belongs to a target entity class. Responsive to a norm of the target entity class being higher including the entity candidate, discarding the entity candidate from the high-precision training set 109; and otherwise, utilizing the entity candidate in a next iteration of training for the target entity class.

At operation 510, the framework 100 determines whether a target performance of the neural NER model 108 has been achieved. If not, then the framework 100 performs another iterative retraining of the neural NER model 108. However, once the framework 100 determines that the target performance has been achieved, the training is complete.

In some implementations, the trained neural NER model 108 may be ready for use as shown at operation 512, where the neural NER model 108 is utilized for named-entity recognition. For instance, the neural NER model 108 may be provided with unlabeled data 107, where the output of the neural NER model 108 includes an indication of an assigned categories for each entity (or potential entity) identified in the unlabeled data 107. After operation 512, the process 500 ends.

Variations on the process 500 are possible. For example, in some implementations, iterations of the process 500 may alternate performance of operations 504 and 506, such that in a first iteration one of operations 504 or 506 is performed, and in the next iteration the other of operations 504 or 506 is performed. In another example, after operation 510 the process may return to operation 502 to allow the neural NER model 108 to be further trained using a different set of unlabeled data while. In yet another example, the training operations 502-510 may be performed by a different computing device than the operation of the neural NER model 108 for performing the named-entity recognition.

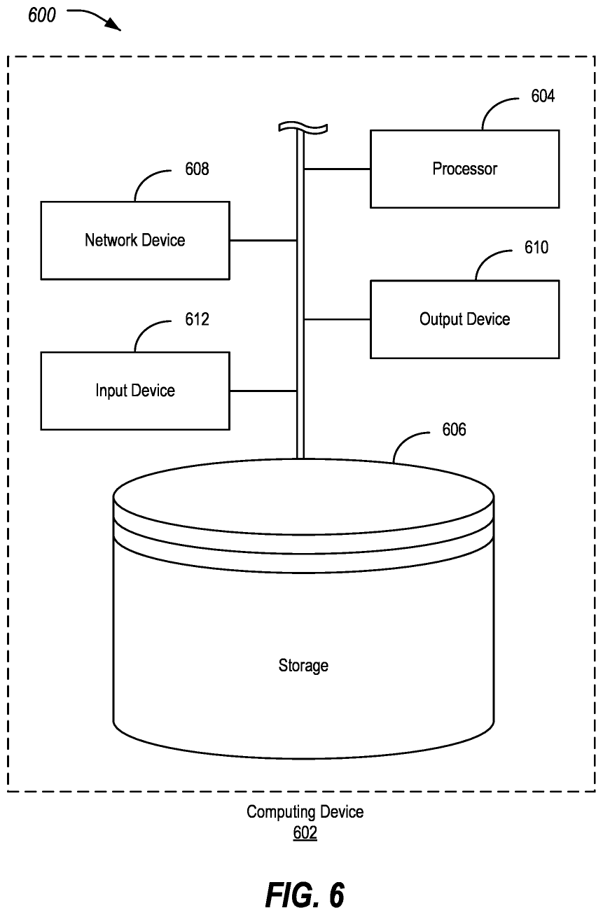

FIG. 6 illustrates an example 600 of a computing device 602 for performing aspects of the co-augmentation framework 100 implementing differentiate positive and negative weak labels 105 with robust training. Referring to FIG. 6, and with reference to FIGS. 1-5, the components of the framework 100, such as the rule augmenter 102, label augmenter 104, rule applier 106, rule selector 111, model labeler 112, and instance filter 115, may be implemented by one or more such computing devices 602. As shown, the computing device 602 includes a processor 604 that is operatively connected to a storage 606, a network device 608, an output device 610, and an input device 612. It should be noted that this is merely an example, and computing devices 602 with more, fewer, or different components may be used.

The processor 604 may include one or more integrated circuits that implement the functionality of a central processing unit (CPU) and/or graphics processing unit (GPU). In some examples, the processors 604 are a system on a chip (SoC) that integrates the functionality of the CPU and GPU. The SoC may optionally include other components such as, for example, the storage 606 and the network device 608 into a single integrated device. In other examples, the CPU and GPU are connected to each other via a peripheral connection device such as peripheral component interconnect (PCI) express or another suitable peripheral data connection. In one example, the CPU is a commercially available central processing device that implements an instruction set such as one of the x86, ARM, Power, or microprocessor without interlocked pipeline stage (MIPS) instruction set families.

Regardless of the specifics, during operation the processor 604 executes stored program instructions that are retrieved from the storage 606. This may include, for example, instructions of the rule augmenter 102, label augmenter 104, rule applier 106, rule selector 111, model labeler 112, and instance filter 115. The stored program instructions, accordingly, include software that controls the operation of the processors 604 to perform the operations described herein. The storage 606 may include both non-volatile memory and volatile memory devices. The non-volatile memory includes solid-state memories, such as not and (NAND) flash memory, magnetic and optical storage media, or any other suitable data storage device that retains data when the system is deactivated or loses electrical power. These data elements may include one or more of the seed rules 103, the weak labels 105, the unlabeled data 107, the neural NER model 108, the seed labels 113, the predicted labels 114, and/or the selected rules 117. The volatile memory includes static and dynamic random-access memory (RAM) that stores program instructions and data during operation of the system.

The GPU may include hardware and software for display of at least two-dimensional (2D) and optionally 3D graphics to the output device 610. The output device 610 may include a graphical or visual display device, such as an electronic display screen, projector, printer, or any other suitable device that reproduces a graphical display. As another example, the output device 610 may include an audio device, such as a loudspeaker or headphone. As yet a further example, the output device 610 may include a tactile device, such as a mechanically raiseable device that may, in an example, be configured to display braille or another physical output that may be touched to provide information to a user.

The input device 612 may include any of various devices that enable the computing device 602 to receive control input from users. Examples of suitable input devices that receive human interface inputs may include keyboards, mice, trackballs, touchscreens, voice input devices, graphics tablets, and the like.

The network devices 608 may each include any of various devices that enable the framework 100 to send and/or receive data from external devices over networks. Examples of suitable network devices 608 include an Ethernet interface, a Wi-Fi transceiver, a cellular transceiver, or a BLUETOOTH or BLUETOOTH low energy (BLE) transceiver, ultra-wideband (UWB) transceiver, or other network adapter or peripheral interconnection device that receives data from another computer or external data storage device, which can be useful for receiving large sets of data in an efficient manner.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as read-only memory (ROM) devices and information alterably stored on writeable storage media such as floppy disks, magnetic tapes, compact discs (CDs), RAM devices, and other magnetic and optical media. The processes, methods, or algorithms can also be implemented in a software executable object. Alternatively, the processes, methods, or algorithms can be embodied in whole or in part using suitable hardware components, such as application specific integrated circuit (ASIC), field-programmable gate array (FPGA), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, life cycle, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method for iteratively training a machine-learning model to perform named-entity recognition of unlabeled text data utilizing a co-augmentation framework, comprising:
integrating a plurality of weak label augmenters of different paradigms, a first of the augmenters extracting first weak labels from unlabeled data, a second of the augmenters extracting second weak labels from the unlabeled data;
filtering the first and second weak labels using an instance filter to update a high-precision training set shared by the plurality of augmenters; and
iteratively retraining the plurality of augmenters using the updated high-precision training set to improve recognition performance over iterations.

2. The method of claim 1, wherein the plurality of weak label augmenters includes a rule augmenter, and further comprising:
extracting, by a rule applier of the rule augmenter, the first weak labels based on the unlabeled data using given seed rules;
using the high-precision training set, as updated based on the first weak labels filtered by the instance filter, to train a neural named entity recognition (NER) model to identify predicted labels in the unlabeled data;
extracting rules from the predicted labels; and
adding selected rules from the extracted rules to enlarge the seed rules.

3. The method of claim 2, further comprising utilizing the neural NER model, once trained, to perform named-entity recognition on an unlabeled input text.

4. The method of claim 1, wherein the plurality of weak label augmenters includes a label augmenter, and further comprising:
training the label augmenter with a robust model labeler, given input seed labels;
extracting the second weak labels from the unlabeled data using the robust model labeler, as trained; and
using the high-precision training set, as updated based on the second weak labels filtered by the instance filter, to retrain the robust model labeler of the label augmenter.

5. The method of claim 4, wherein the label augmenter adopts a loss function that includes a weighting of components, the components including one or more of:
an unlikelihood objective for class contradiction, for maximizing a probability difference between entities belonging to a correct class in the high-precision training set as compared to entities belonging to another class in the high-precision training set;
a minmax entropy optimization approach for prototype re-estimation to minimize entropy given to training data and to maximize entropy on entities that cannot be labeled, to avoid bias against unlabeled entities; and/or
an anchor regularizer to limit prototype drift at a current iteration to a maximum distance from prototype embedding at one or more initial iterations.

6. The method of claim 5, wherein each class is considered as a centroid of all instances in that class and wherein distance measurements utilized by the loss function are computed as Euclidean distance from the centroid.

7. The method of claim 5, wherein the minmax entropy optimization approach utilizes a gradient reversal layer such that data with a label contributes a positive entropy in the loss function, and data without a label contributes a negative entropy in the loss function.

8. The method of claim 5, wherein the label augmenter implements the model labeler as a bidirectional encoder representations from transformer (BERT) masked-language model.

9. The method of claim 1, wherein the instance filter utilizes a rule-based constraint functions to remove the weak labels that match to one or more predefined constraint rules to prevent their incorporation into the high-precision training set.

10. The method of claim 1, wherein the instance filter utilizes a neural constraint module to jointly learn and filter negative instances, where the neural constraint module only filters instances that have been added by both of the first and second augmenters.

11. The method of claim 1, wherein the instance filter utilizes an integrated gradients-based approach to predict whether or not an entity candidate belongs to a target entity class.

12. The method of claim 11, further comprising:
responsive to a norm of the target entity class being higher including the entity candidate, discarding the entity candidate from the high-precision training set; and
otherwise, utilizing the entity candidate in a next iteration of training for the target entity class.

13. A system for training a machine-learning model to perform named-entity recognition of unlabeled text data utilizing a co-augmentation framework, comprising:
one or more computing devices configured to:
integrate a plurality of weak label augmenters of different paradigms, a first of the augmenters generating first weak labels from unlabeled data, a second of the augmenters generating second weak labels from the unlabeled data;
filter the first and second weak labels using an instance filter to update a high-precision training set shared by the plurality of augmenters; and
iteratively retrain the plurality of augmenters using the updated high-precision training set to improve recognition performance over iterations.

14. The system of claim 13, wherein the plurality of weak label augmenters includes a rule augmenter, and the one or more computing devices are further configured to:
extract, by a rule applier of the rule augmenter, the first weak labels based on the unlabeled data using given seed rules;
use the high-precision training set, as updated based on the first weak labels filtered by the instance filter, to train a neural named entity recognition (NER) model to identify predicted labels in the unlabeled data;
extract rules from the predicted labels; and
add selected rules from the extracted rules to enlarge the seed rules.

15. The system of claim 14, wherein the one or more computing devices are further configured to utilize the neural NER model, once trained, to perform named-entity recognition on an unlabeled input text.

16. The system of claim 13, wherein the plurality of weak label augmenters includes a label augmenter, and the one or more computing devices are further configured to:
train the label augmenter with a robust model labeler, given input seed labels;
extract the second weak labels from the unlabeled data using the robust model labeler, as trained; and
use the high-precision training set, as updated based on the second weak labels filtered by the instance filter, to retrain the robust model labeler of the label augmenter.

17. The system of claim 16, wherein the label augmenter adopts a loss function that includes a weighting of components, the components including one or more of:
an unlikelihood objective for class contradiction, for maximizing a probability difference between entities belonging to a correct class in the high-precision training set as compared to entities belonging to another class in the high-precision training set;
a minmax entropy optimization approach for prototype re-estimation to minimize entropy given to training data and to maximize entropy on entities that cannot be labeled, to avoid bias against unlabeled entities; and/or
an anchor regularizer to limit prototype drift at a current iteration to a maximum distance from prototype embedding at one or more initial iterations.

18. The system of claim 17, wherein each class is considered as a centroid of all instances in that class and wherein distance measurements utilized by the loss function are computed as Euclidean distance from the centroid.

19. The system of claim 17, wherein the minmax entropy optimization approach utilizes a gradient reversal layer such that data with a label contributes a positive entropy in the loss function, and data without a label contributes a negative entropy in the loss function.

20. The system of claim 17, wherein the label augmenter implements the model labeler as a bidirectional encoder representations from transformer (BERT) masked-language model.

21. The system of claim 13, wherein the instance filter utilizes a rule-based constraint functions to remove the weak labels that match to one or more predefined constraint rules to prevent their incorporation into the high-precision training set.

22. The system of claim 13, wherein the instance filter utilizes a neural constraint module to jointly learn and filter negative instances, where the neural constraint module only filters instances that have been added by both of the first and second augmenters.

23. The system of claim 13, wherein the instance filter utilizes an integrated gradients-based approach to predict whether or not an entity candidate belongs to a target entity class.

24. The system of claim 23, wherein the one or more computing devices are further configured to:
responsive to a norm of the target entity class being higher including the entity candidate, discard the entity candidate from the high-precision training set; and
otherwise, utilize the entity candidate in a next iteration of training for the target entity class.
